(19) United States
(12) Patent Application Publication
(10) Pub. No.: US 2025/0141035 A1
(43) Pub. Date: May 1, 2025

(54) BATTERY PACK

(71) Applicant: LG ENERGY SOLUTION, LTD., Seoul (KR)

(72) Inventors: Chang Hyeon YANG, Daejeon (KR); Bo Ra JEON, Daejeon (KR); Dae Gil KIM, Daejeon (KR); Hyoung Suk LEE, Daejeon (KR); Ju Hwan SHIN, Daejeon (KR)

(73) Assignee: LG ENERGY SOLUTION, LTD., Seoul (KR)

(21) Appl. No.: 18/683,093

(22) PCT Filed: Jun. 1, 2023
(86) PCT No.: PCT/KR2023/007552

§ 371 Date: Feb. 12, 2024

(30) Foreign Application Priority Data
Jun. 3, 2022 (KR) 10-2022-0068280

(51) Int. Cl. H01M 50/358; H01M 50/209; H01M 50/291

(52) U.S. Cl. CPC H01M 50/358; H01M 50/209; H01M 50/291

(57) ABSTRACT

A battery pack includes a cell stack including one or more battery cells, including a pack case. The pack case includes a base plate supporting a lower portion of the cell stack; a main wall extending across the base plate and coupled to a center portion of the base plate; a side wall having a hollow shape and including a gas venting path therein, and coupled along an edge of the base plate; and a plurality of supplementary wall having a front end coupled to the main wall, and a rear end coupled to the side walls. The supplementary wall includes a first partition member including a pair of ribs along a longitudinal direction of the supplementary wall, and a second partition member coupled to the first partition member. At least one of the first partition member and the second partition member includes a first hole between the ribs.

### TECHNICAL FIELD

The present invention relates to a battery pack. More particularly, the battery pack of the present invention is characterized in that it contains a plurality of cell stacks each of which containing one or more battery cells and is capable of releasing high temperature gases generated internally to the exterior by using a supplementary wall that separates each cell stack and includes a gas flow path therein.

This application claims the benefit of priority to Korean Patent Application No. 10-2022-0068280, filed on Jun. 3, 2022, and entire contents of the Korean patent application are incorporated herein by reference.

### BACKGROUND ART

Types of secondary batteries include lithium-ion cells, lithium polymer cells, nickel-cadmium cells, nickel-hydrogen cells, nickel-zinc cells, etc. These unit secondary battery cells, i.e. unit battery cells, have an operating voltage of about 2.5 V to 4.2 V. Therefore, if a higher output voltage is required, a plurality of battery cells may be connected in series to form a battery pack. In addition, depending on the charge and discharge capacity required for the battery pack, a plurality of battery cells may be connected in parallel to form a battery pack. Thus, the number of battery cells included in the battery pack may be varied depending on the required output voltage or charge/discharge capacity.

For example, when forming a battery pack by connecting a plurality of battery cells in series/parallel, it is common to first form a cell stack of the plurality of battery cells, and then add other components to form a battery pack using the cell stack.

Cell stack refers to a component with a plurality of secondary batteries connected in series or parallel, and battery pack refers to a component with a plurality of cell stacks connected in series or parallel to increase capacity, power output, etc.

FIG. 1(a) is an exploded perspective view of a typical cell stack mounted in a battery pack. Referring to FIG. 1(a), a busbar frame and end plates are coupled to the front and rear of the cell stack, respectively, formed by stacking a plurality of battery cells. The cell stack may also be enclosed and protected by a U-shaped module frame or the like, as shown in FIG. 1(b).

On the other hand, it is important for the battery pack to release the high temperature gases generated by each cell stack effectively. If the high temperature gases generated during the charging and discharging process are not effectively released, heat accumulation will occur, which will accelerate the degradation of the cell stack, and in some cases, ignition or explosion may occur. In addition, the heat of the gases can be transferred to other normally operating cell stacks, resulting in the degradation or explosion of the entire battery cells contained within the battery pack.

### RELATED-ART DOCUMENT

Korean Patent Application Publication No. 10-2022-0014027.

### DISCLOSURE

### Technical Problem

The present invention is directed to solving the above mentioned problems, and aims to provide a battery pack capable of rapidly venting high temperature gases to the outside when degradation occurs in a cell stack of any one of the plurality of cell stacks, to prevent the battery pack from igniting or exploding.

Further, it is an object of the present invention to provide a battery pack capable of preventing the transfer of heat of the high temperature gas to other neighboring cell stacks when degradation occurs in any of the cell stacks of the plurality of cell stacks, to prevent thermal runaway occurs.

Other objects and advantages of the present invention will be understood from the following description, and will become apparent from the example embodiments of the present invention. Furthermore, it will be readily apparent that the objects and advantages of the present invention may be realized by the methods and combinations thereof disclosed in the claims of the patent.

### Technical Solution

According to the present invention, a battery pack containing a cell stack including one or more battery cells, including a pack case having a space in which the cell stack is placed, the pack case including: a base plate supporting a lower portion of the cell stack; a main wall extending across the base plate and coupled to a center portion of the base plate; a side wall having a hollow shape and including a gas venting path therein, and coupled along a periphery of an edge of the base plate; and a plurality of supplementary walls, each of the plurality of supplementary walls having a front end coupled to the main wall, and a rear end coupled to the side wall, a first partition member including a first pair of ribs extending in a longitudinal direction along a first side of the first partition member, and a second partition member coupled to the first partition member, wherein at least one of the first partition member and the second partition member includes at least one first hole between the first pair of ribs.

Each of the plurality of supplementary walls may be arranged to be separately spaced along a longitudinal direction of the main wall.

The first pair of ribs may be vertically spaced from each other by a predetermined distance.

The second partition member may be coupled with the first partition member and face the first pair of ribs of the first partition member.

The at least one first hole may include a plurality of the first holes on one side of each of the plurality of supplementary walls.

A rear end of the first partition member may have an opening in a space between the first pair of ribs.

Each of the plurality of supplementary walls may be inserted into the side wall to allow the opening to be in communicating with the gas venting path.

Each of the plurality of supplementary walls may include a gas flow path closed on an upper surface and a lower surface by the first pair of ribs, and closed on opposite sides by the first partition member and the second partition member, the gas flow path being open to the outside through the at least one first hole and the opening.

The second partition member may include a second pair of ribs extending in a longitudinal direction along a first side of the second partition member, and the supplementary wall may include a second hole penetrating between the second pair of ribs included in the second partition member on a side opposite to the at least one first hole.

The second pair of ribs of the second partition member may be formed to not overlapping with the first pair of ribs formed on the first partition member.

The second pair of ribs of the second partition member is located on top of the first pair of ribs formed on the first partition member, and the at least one first and second hole may be formed on opposite sides of the supplementary wall at a lower and upper portion, respectively.

A rear end of each of the first partition member and the second partition member may have an opening between the second pair of ribs to form an upper opening.

A rear end of each of the first partition member and the second partition member have an opening between the first pair of ribs on the first partition member to form a lower opening, and each of the plurality of supplementary walls may be inserted into the side wall to allow the upper opening and the lower opening to be in communication with the gas venting path.

Each of the plurality of supplementary walls may include the at least one first hole and the second hole on each side.

Each of the plurality of supplementary walls may include an upper gas flow path closed on an upper surface and a lower surface by the second pair of ribs formed in the second partition member, and closed on opposite sides by the first partition member and the second partition member, and a lower gas flow path below the upper gas flow path, closed on an upper surface and a lower surface by the first pair of ribs formed in the first partition member and closed on opposite sides by the first partition member and the second partition member, and the upper gas flow path and the lower gas flow path may not be in communication with each other within the supplementary wall.

### Advantageous Effects

According to the present invention, it is possible to prevent the battery pack from igniting or exploding even if degradation or high temperature gases are generated in the cell stack contained in the battery pack.

In addition, according to the present invention, it is possible to prevent thermal runaway caused by transferring high temperature gas generated in a cell stack to a neighboring other cell stack.

Furthermore, according to the present invention, a plurality of a rib shape can be applied to a wall installed within the battery pack and separating each cell stack to improve rigidity while forming a pathway for gas transfer.

### BRIEF DESCRIPTION OF THE DRAWINGS

FIG. 1 is an exploded perspective view of a conventional cell stack.

FIG. 2 is a perspective view of a pack case of the present invention.

FIG. 3 illustrates the supplementary wall combined with the base plate.

FIG. 4 is a front perspective view of a supplementary wall contained in a battery pack according to a first embodiment.

FIG. 5 is a rear perspective view of the supplementary wall from FIG. 4.

FIG. 6 is an exploded perspective view of the supplementary wall from FIG. 4.

FIG. 7 is a top view of a pack case of a battery pack according to a first embodiment.

FIG. 8 is a diagram illustrating a first partition member of an supplementary wall included in a battery pack according to a second embodiment.

FIG. 9 is a perspective view of a supplementary wall including the first partition member of FIG. 8.

FIG. 10 is a front perspective view of a supplementary wall included in a battery pack according to a third embodiment.

FIG. 11 is a rear perspective view of the supplementary wall from FIG. 10.

FIG. 12 is an exploded perspective view of the supplementary wall of FIG. 10.

FIG. 13 is a side view of a second partition member included in the supplementary wall of FIG. 12.

FIG. 14 is a perspective view of the second partition member of FIG. 13.

FIG. 15 is a side view of a first partition member included in the supplementary wall of FIG. 12.

FIG. 16 is a perspective view of the first partition member of FIG. 15.

FIG. 17 is a perspective view of a pack case included in a battery pack according to a third embodiment.

### DETAILED DESCRIPTION OF THE PREFERRED EMBODIMENTS

Hereinafter, the present invention will be described in detail. Prior to this, terms or words used in the present specification and claims should not be restrictively interpreted as ordinary meanings or dictionary-based meanings, but should be interpreted as meanings and concepts consistent with the technical ideas of the present invention on the basis of the principle that an inventor can properly define the concept of a term to describe and explain his or her invention in the best way.

Therefore, the exemplary embodiments described herein and the configurations illustrated in the drawings in present disclosure are just a preferred embodiments of the invention and are not representative of all of the technical ideas of the invention, so that it is to be understood that there may be various equivalents and modifications that may be substituted for them in the present invention.

Furthermore, in the description of the invention, detailed descriptions of relevant known configurations or features are ruled out if it is determined that the detailed description would obscure the essence of the invention.

The embodiments disclosed herein are provided for more perfect explanation of the present disclosure, and thus the shape, size and the like of components may be exaggerated, omitted or simplified in the drawings for better understanding. Thus, the size and ratio of components in the drawings do not wholly reflect the actual size and ratio.

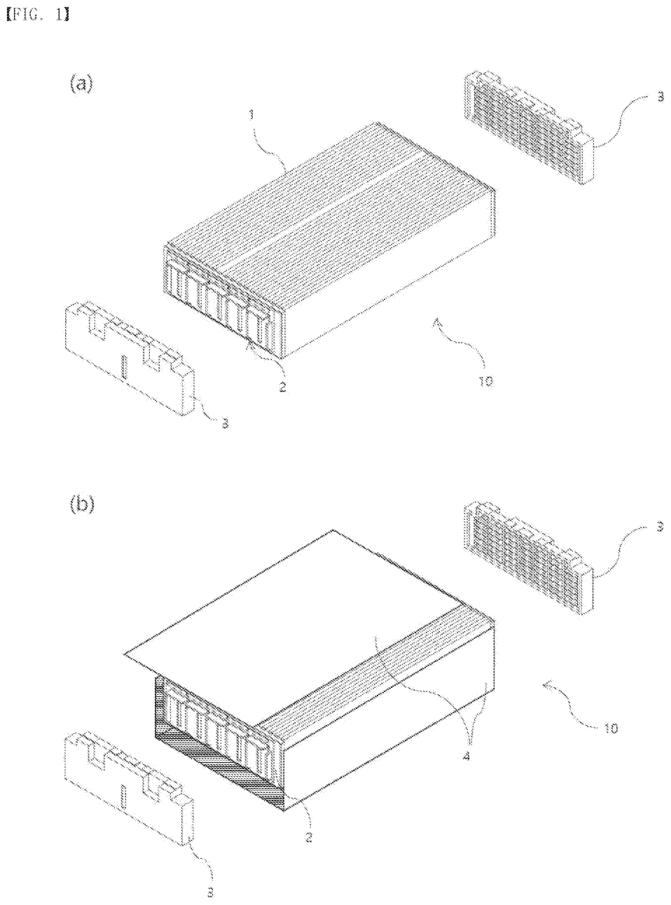

The present invention relates to a battery pack having a structure capable of separating a space in which a plurality of cell stacks is contained, and at the same time, in the event of high temperature gases being generated in any one of the cell stacks, rapidly releasing the gases to the outside. Here, the cell stack may be in the form of one or more battery cells stacked, as shown in FIG. 1(a), or in the form of a battery module enclosed by a module frame around its perimeter, as shown in FIG. 1(b).

A battery pack of the present invention includes a pack case (1000) that provides a space in which a cell stack is located.

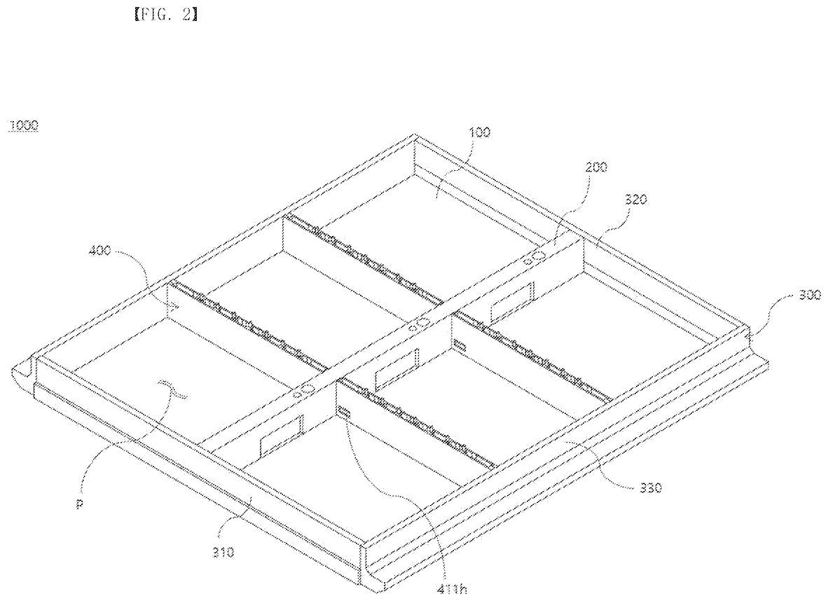

FIG. 2 is a perspective view of the pack case 1000 of the present invention.

The pack case 1000 includes a base plate 100, a main wall 200, side walls 300, and a supplementary wall 400, as shown in the FIG. 2.

In addition to the pack case 1000 above, the battery pack of the present invention may further include a top cover (not shown). The top cover may be combined with the pack case 1000 to form a single housing that contains a plurality of cell stacks.

The base plate 100 is positioned at a lower portion of the battery pack, in a configuration wherein the cell stack is settled, and supports a lower portion of the cell stack.

The main wall 200 is formed to extend across the base plate 100 and is coupled to the center of the base plate 100.

This main wall 200 divides the space inside the pack case 1000 into two main sections so that cell stacks on both sides settle on the base plate 100 symmetrically with respect to each other relative to the main wall 200. In other words, cell stacks located on one side of the main wall 200 and cell stacks located on the other side of the main wall 200 are separated by the main wall 200.

Inside the main wall 200 may be located wires or busbars or the like that are electrically connected to the cell stacks settling on the base plate 100. Here, each cell stack is settled on the base plate 100 with its included end plate facing the main wall 200.

The side wall 300 is coupled along the periphery of the edge of the base plate 100 in a hollow form.

The side wall 300 provides support for the side portions of cell stacks settling on the base plate 100 and provides protection from the outside.

The side wall 300 having the hollow structure includes a gas venting path 331 inside which gas can flow.

The side wall 300 includes a front frame 310, a rear frame 320, and a pair of side frames 330, as shown in FIG. 2.

The front frame 310 and rear frame 320 support one side of the outermost cell stack, and the side frame 330 supports the rear of the settled cell stack.

The gas venting path 331 is preferably included in the side frame 330. In addition, a gas venting path 331 may also be formed in a portion of the front frame 310 or the rear frame 320 to be in communication with the gas venting path 331 of the side frame 330.

The side wall 300 may further include a gas outlet 321 through which a gas venting path 331 formed in the side wall 300 is open to the outside.

The supplementary wall 400 is coupled to the base plate 100 to repartition the containing space P partitioned by the main wall 200.

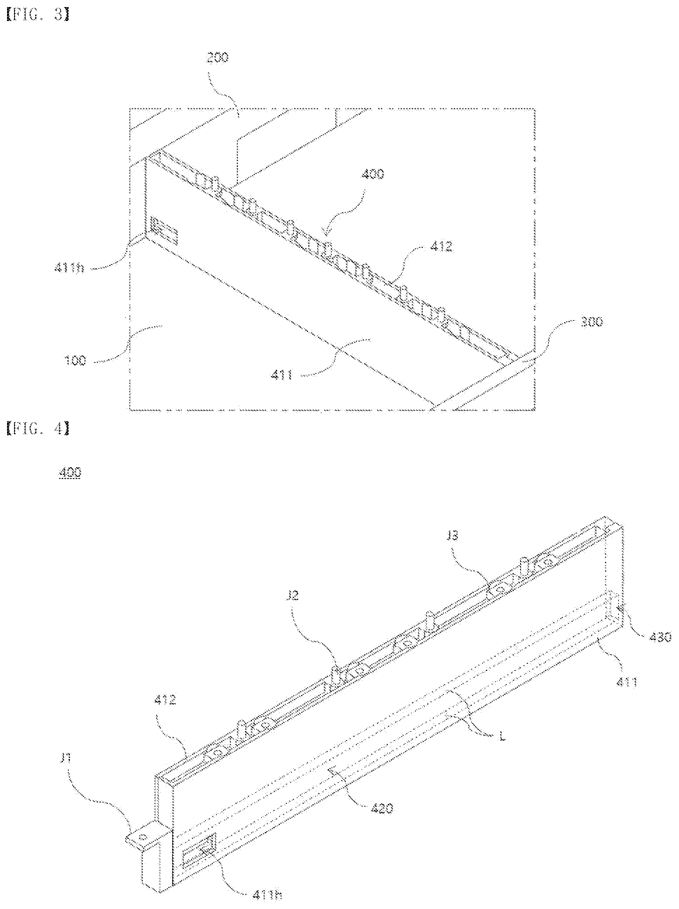

FIG. 3 illustrates a supplementary wall 400 coupled to the base plate 100.

The supplementary wall 400 formed by the coupling of the first partition member 411 and the second partition member 412 is coupled at both ends to the main wall 200 and the side wall 300, respectively, as shown in FIG. 3.

The supplementary walls 400 are arranged to be spaced apart at regular intervals along the longitudinal direction of the main wall 200 on both sides of the main wall 200, as shown in FIG. 2. Here, the cell stack is contained in a containing space P partitioned by the main wall 200, and a pair of neighboring supplementary walls 400, respectively.

The supplementary wall 400 of the present invention is characterized in that it has the form of a pair of partition members coupled together, and includes a gas flow path 420 formed due to a ribbed structure (L) formed on the coupling surface of the partition members, and a hole penetrated to allow the gas flow path 420 to be in communication with the containing space (P).

The battery pack of the present invention, the supplementary wall 400 can be categorized into several embodiments based on the rib structure and the hole structure.

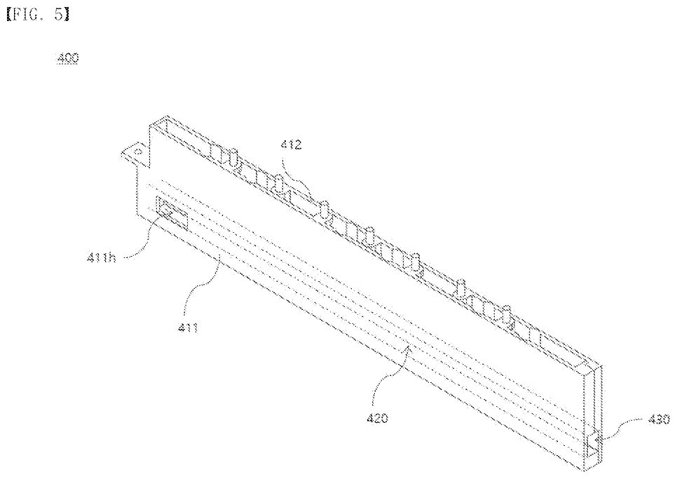

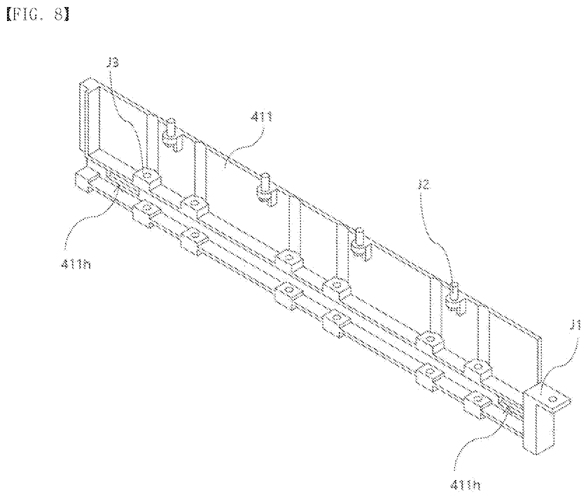

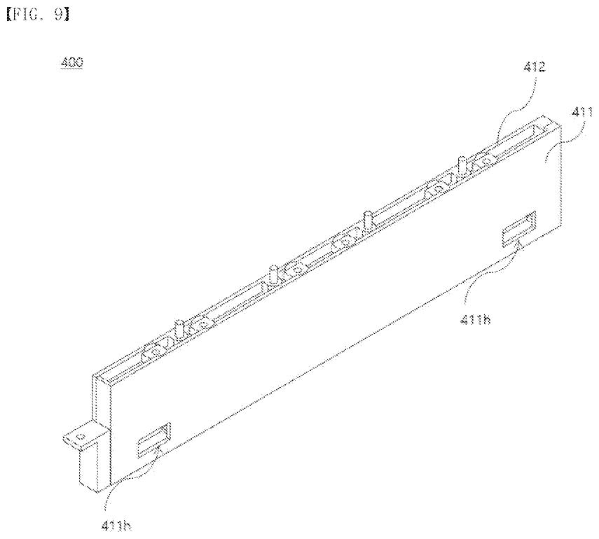

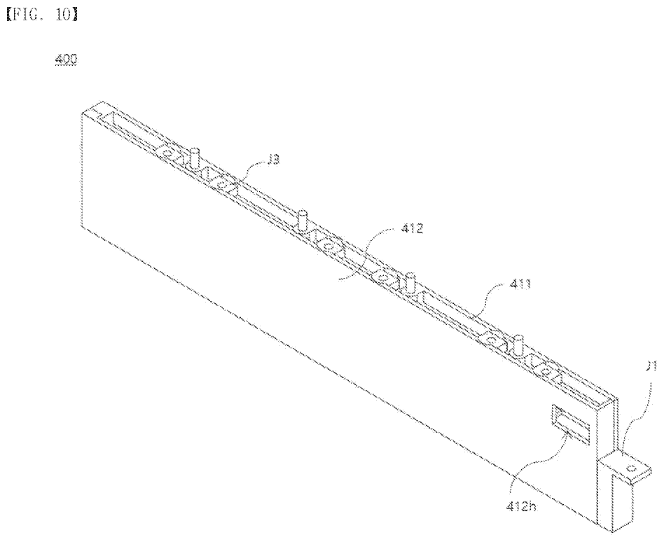

FIG. 4 to FIG. 7 relate to a supplementary wall 400 included in a battery pack according to a first embodiment, FIG. 8 to FIG. 9 relate to a supplementary wall 400 included in a battery pack according to a second embodiment, and FIG. 10 to FIG. 17 relate to a supplementary wall 400 included in a battery pack according to a third embodiment.

Hereinafter, each embodiment will be described with reference to the accompanying drawings.

### MODES OF INVENTION

### First Embodiment

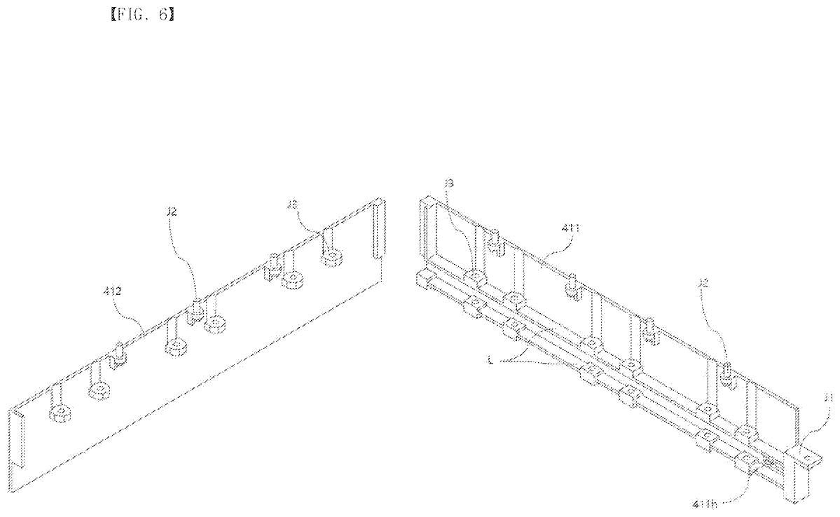

FIG. 4 is a front perspective view of an supplementary wall 400 included in a battery pack according to a first embodiment, and FIG. 5 is a rear perspective view of the supplementary wall 400 of FIG. 4.

The supplementary wall (400) includes a main joint (J1) projecting forwardly at its front end, and is engaged with the main wall (200) in such a way that the main joint (J1) is inserted into the main wall (200). Here, the supplementary wall 400 may be secured to the main wall 200 in such a way that the inserted main joints J1 and the main wall 200 are screwed together.

The supplementary wall (400) includes a main joint (J1) projecting forwardly at its front end, and is engaged with the main wall (200) in such a way that the main joint (J1) is inserted into the main wall (200). Here, the supplementary wall 400 may be secured to the main wall 200 by a screwed connection between the inserted main joint J1 and the main wall 200.

The supplementary wall 400 has a hollow structure on the inside. Specifically, the supplementary wall 400 includes a gas flow path 420 formed to extend along a longitudinal direction to allow gas to flow therein, and an opening 430 formed at a rear end to allow the gas flow path 420 to open to the outside. Furthermore, it also includes a first hole 411h formed at one side to allow the gas flow path 420 to open to the outside.

The supplementary wall 400 is inserted and joined to the main wall 200 by a front end in which the main joint J1 is formed, and by a rear end inserted and joined to the side wall 300 so that the opening 430 is in communication with the gas venting path 331 of the side wall 300. In this case, the first hole 411h is in communication with the gas flow path 420 by at least one containing space P formed by the supplementary wall 400. Thus, the containing space P is in communication with the gas venting path 331 of the side wall 300 via the gas flow path 420.

A front end of the two ends of the gas flow path 420 is closed by a configuration of the main joint J1 or the like, as shown in FIG. 4, and a rear end is opened by an opening 430.

On an upper side of the supplementary wall 400, a top joint J2 may be formed that is engageable with an upper cover that is engaged with the pack case 1000 to cover the cell stack contained in the pack case 1000.

FIG. 6 is an exploded perspective view of the supplementary wall 400 of FIG. 4.

The supplementary wall 400 includes a first partition member 411 and a second partition member 412 that engages the first partition member 411, as shown in FIG. 6.

The first partition member 411 may include a vertically perforated wall joint J3 for screw connection to an inner surface that is coupled to the second partition member 412, as shown in FIG. 6. More specifically, the wall joint J3 included in the first partition member 411 is preferably formed on each of the ribs L as shown in FIG. 6.

The second partition member 412 may also include a wall joint J3 vertically perforated for screw connection on the inner side where it is coupled with the first partition member 411. Here, the wall joint J3 included in the first partition member 411 and the second partition member 412 are preferably formed in positions corresponding to each other up and down. Therefore, when the first partition member 411 and the second partition member 412 are engaged against each other, the wall joint J3 formed on each of the partition members are overlapped in a position corresponding to each other in the vertical direction, and the first partition member 411 and the second partition member 412 are engaged by a bolt or the like penetrating the wall joint J3 formed on each of the partition members. In this case, a bolt through each of the wall joints J3 may also penetrate the base plate 100 of the pack case 1000 to engage and secure the supplementary wall 400 with the base plate 100. Here, the bolts penetrate the ribs L of the first partition member 411 in a vertical direction to engage the supplementary wall 400.

The first partition member 411 includes a pair of ribs L formed extending along the longitudinal direction of the supplementary wall 400.

The pair of ribs L is configured to be spaced apart by a predetermined distance up and down, and the first partition member 411 including the ribs L is coupled with the second partition member 412 so that the space between the ribs L forms the gas flow path 420. In other words, a passage-shaped gas flow path 420 is formed by covering the space between the ribs L by the second partition member 412.

In other words, the supplementary wall 400 of the present invention includes a gas flow path 420 that is closed on its upper and lower sides by the pair of ribs L, and is closed on both sides by the first partition member 411 and the second partition member 412.

The gas flow path 420 is closed on the upper and lower sides by the pair of ribs L, and closed on both sides by the first partition member 411 and the second partition member 412.

It is preferable that the first partition member 411 is penetrated at the rear by extending into the space between the pair of ribs L to open in the rearward direction of the first partition member 411, and the second partition member 412 has a structure with an open rear corresponding to the penetrated area of the first partition member 411 to prevent blockage of the penetrated area of the first partition member 411 when combined with the first partition member 411 as shown in FIG. 5.

The penetrated area forms an opening 430 of the supplementary wall 400 by engagement of the first partition member 411 and the second partition member 412.

Further, at least one of the first partition member (411) or the second partition member (412) coupled with the first partition member (411) includes a first hole (411h) that penetrates between the ribs (L) included in the first partition member (411).

Therefore, the gas flow path 420 formed by the coupling of the first partition member 411 and the second partition member 412 can be opened to the outside through the opening 430 and the first hole 411h.

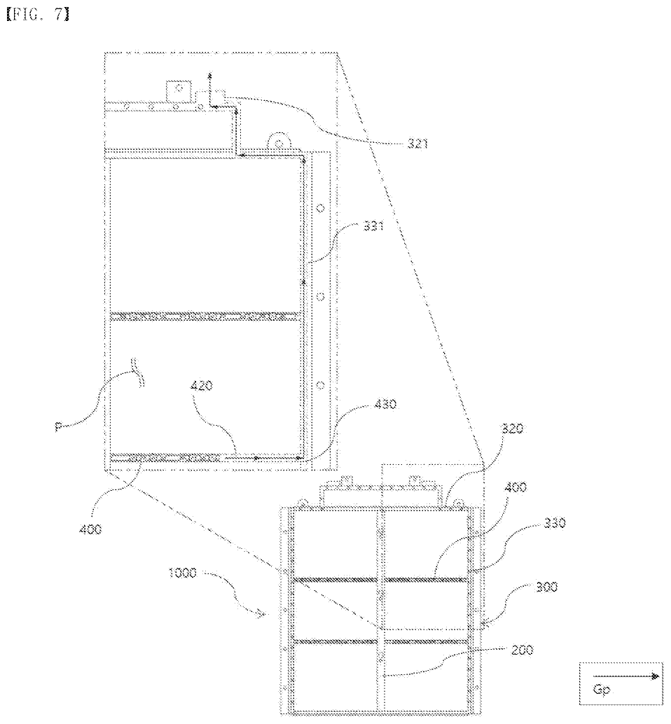

FIG. 7 is a top view of a pack case 1000 of a battery pack according to a first embodiment.

Referring to the partially enlarged view of FIG. 7 and the gas flow path, the gas flow path 420 formed in the supplementary wall 400, and the gas Gp flowing through the gas venting path 331 of the side wall 300 coupled with the supplementary wall 400, that is, the side frame 330, is discharged to the outside through the gas outlet 321 of the rear frame 320 coupled with the side frame 330.

The battery pack according to the first embodiment of the present invention can be effectively vented to the outside through the supplementary wall 400, even if high temperature gases are generated in any one of the containing spaces P in which the cell stack is contained, as shown in FIG. 7.

### Second Embodiment

FIG. 8 illustrates a first partition member 411 of a supplementary wall 400 included in a battery pack according to a second embodiment, and FIG. 9 illustrates a perspective view of a supplementary wall 400 including the first partition member 411 of FIG. 8.

The battery pack according to a second embodiment of the present invention is characterized in that a plurality of first holes 411h are formed on one side of the supplementary wall 400.

The supplementary wall 400 included in the battery pack according to the second embodiment of the present invention, as shown in FIGS. 8 and 9, includes at least two first holes 411h which is formed to penetrate at least one of the first partition member 411 and the second partition member 412 in order to allow the gas flow path 420 to be in communication with the containing space P. The plurality of the first holes 411h are preferably configured adjacent to both ends of the supplementary wall 400, as shown.

If the first holes 411h are formed adjacent to each of the two ends of the supplementary wall 400 as described above, gases generated by the cell stack while being blocked by the main wall 200 and the sidewalls 300 can travel along the outer surface of the main wall 200 and the side walls 300 and effectively enter the first holes 411h formed at each end of the supplementary wall 400.

### Third Embodiment

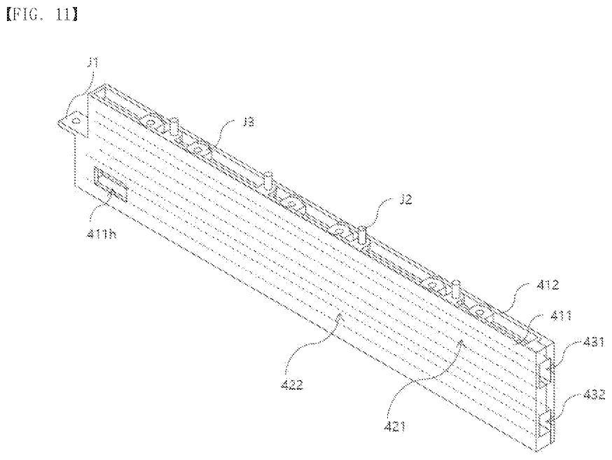

FIG. 10 is a front perspective view of a supplementary wall 400 included in a battery pack according to a third embodiment, and FIG. 11 is a rear perspective view of a supplementary wall 400 included in a battery pack according to a third embodiment.

The supplementary wall 400 includes a main joint J1 projecting forwardly therefrom, as shown in FIG. 10, and is engaged with the main wall 200 in such a way that the main joint J1 is inserted into the main wall 200. Here, the supplementary wall 400 may be fixed to the main wall 200 by means of the inserted main joint J1 and the main wall 200 being screwed together.

In addition, on an upper side of the supplementary wall 400, a top joint J2 may be formed that is engageable with an upper cover that is engaged with the pack case 1000 to cover the cell stack contained in the pack case 1000.

The battery pack according to a third embodiment of the present invention is characterized in that both the first partition member 411 and the second partition member 412 have a ribbed (L) configuration.

More specifically, a battery pack according to a third embodiment of the present invention includes a supplementary wall (400) including a first partition member (411) including a pair of ribs (L) extending along a longitudinal direction on one side, and a second partition member (412) coupled to the first partition member (411) and including a pair of ribs (L) extending along a longitudinal direction on one side.

In other words, the first partition member 411 and the second partition member 412 of the supplementary wall 400 included in the battery pack according to the third embodiment each include a pair of ribs L on opposing inner sides.

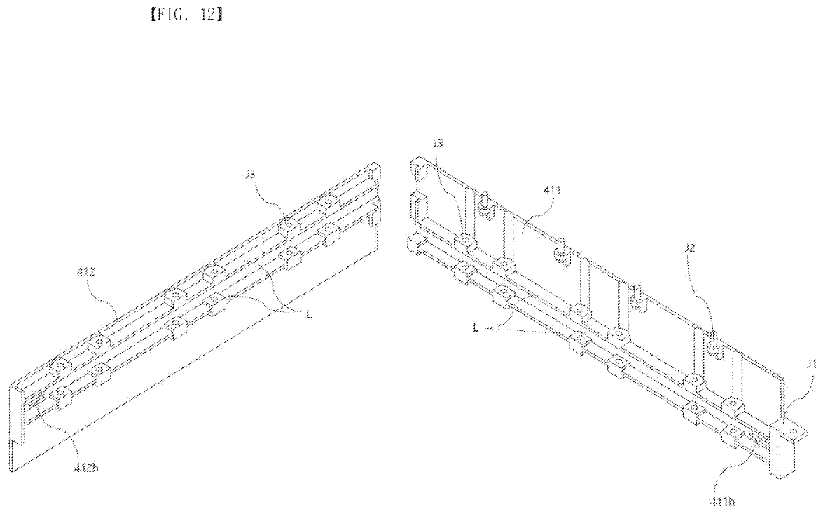

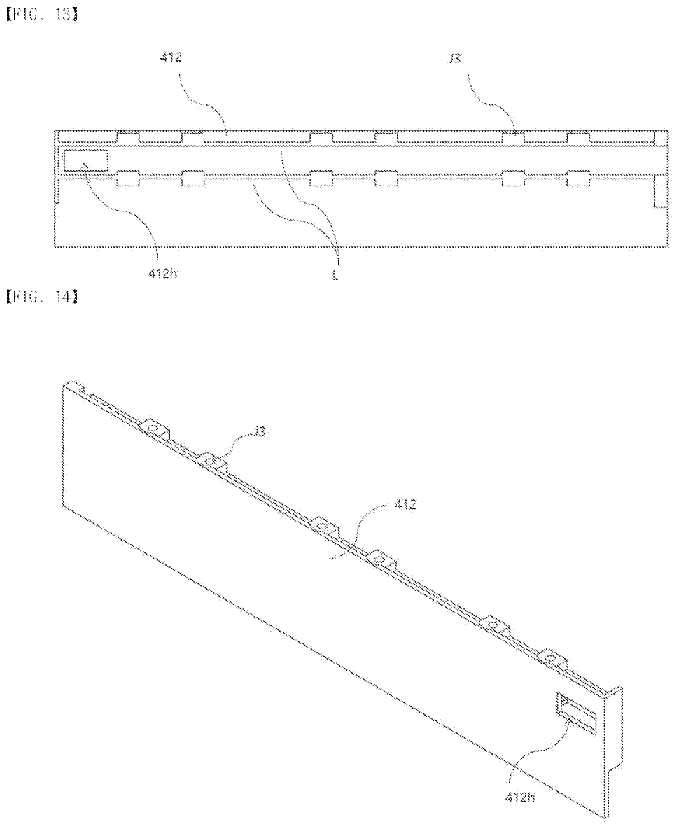

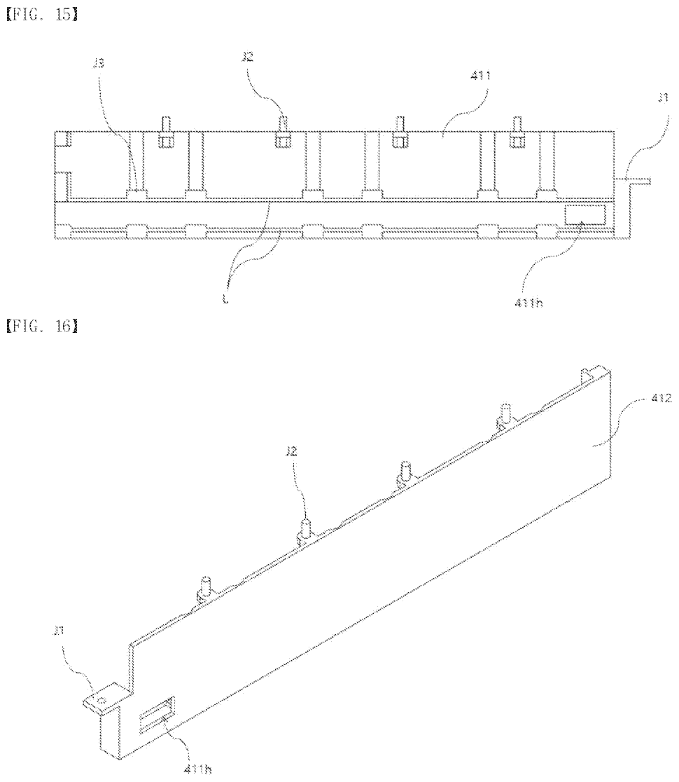

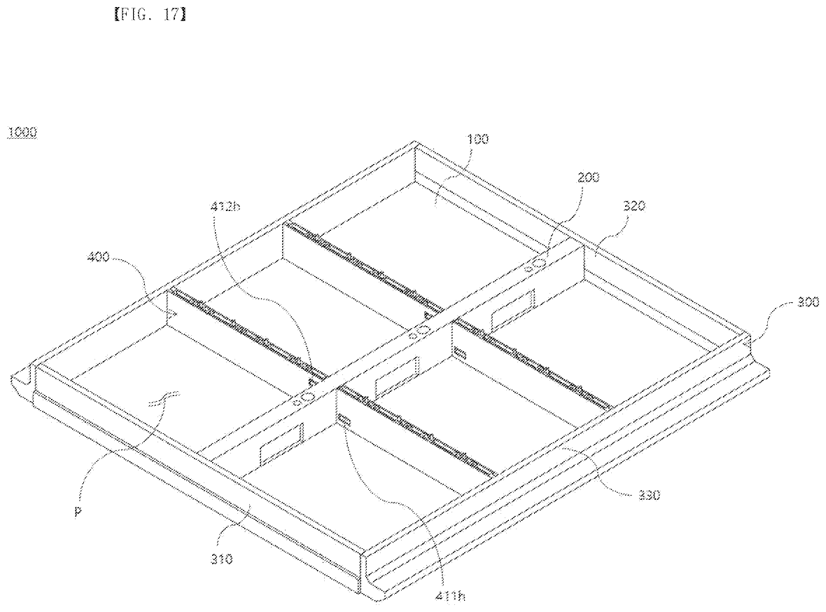

FIG. 12 is an exploded perspective view of a supplementary wall 400 included in a battery pack according to a third embodiment, FIG. 13 is a side view of a second partition member 412 included in the supplementary wall 400 of FIG. 12, FIG. 14 is a perspective view of the second partition member 412 of FIG. 13, FIG. 15 is a side view of a first partition member 411 included in the supplementary wall 400 of FIG. 12, and FIG. 16 is a perspective view of the first partition member 411 of FIG. 15.

According to FIG. 12 above, the first partition member 411 and the second partition member 412 each include a pair of ribs L.

As shown in FIG. 12, the ribs L of the second partition member 412 are located at the top in order to not overlap the ribs L of the first partition member 411, and the ribs L of the first partition member 411 are located at the bottom in order to not overlap the ribs L of the second partition member 412.

The space between the pair of ribs L formed at the top in the second partition member 412 forms the upper gas flow path 421 by the engagement of the first partition member 411 and the second partition member 412. Furthermore, the space between the pair of ribs L formed at the bottom in the first partition member 411 forms a lower gas flow path 422 by the combination of the second partition member 412 and the first partition member 411. Here, the upper gas flow path 421 and the lower gas flow path 422 are separated and isolated with each other and are designed to be not in communication with each other. Therefore, the ribs L located below the pair of ribs L formed on the second partition member 412 and the ribs L located above the pair of ribs L formed on the first partition member 411 are preferably spaced apart by a predetermined distance.

Thus, the upper gas flow path 421 of the supplementary wall 400 included in the battery pack according to the above third embodiment is formed by being closed on its upper surface by a pair of ribs L formed in the second partition member 412, and closed on both sides by the first partition member 411 and the second partition member 412. Further, the lower gas flow path 422 is formed by being closed on its upper surface by a pair of ribs L formed in the first partition member 411, and closed on both sides by the first partition member 411 and the second partition member 412.

The first partition member 411 and the second partition member 412 extend into the space between the pair of ribs L and are penetrated rearward, as shown in FIG. 12, in order that the space between the ribs L is open toward the rear end of each partition member. Thus, the supplementary wall 400 included in the battery pack according to the third embodiment includes an upper opening 431 located at the top and a lower opening 432 located at the bottom, as shown in FIG. 11, wherein the first partition member 411 and the second partition member 412 are engaged.

The upper opening 431 is in communication with the upper gas flow path 421, and the lower opening 432 is in communication with the lower gas flow path 422.

The supplementary wall 400 included in the battery pack according to a third embodiment of the present invention is inserted at its rear end into the side wall 300 to allow the upper opening 431 and the lower opening 432 to be in communication with the gas venting path 331 of the side wall 300.

The second partition member 412 may include a wall joint J3 penetrated in a vertically oriented direction for screw connection to an inner surface that engages the first partition member 411, as shown in FIGS. 12 to 14. More specifically, the wall joint J3 included in the second partition member 412 is formed on each rib L preferably.

The first partition member 411 may also include a vertically perforated wall joint J3 for screw connection to an inner surface that engages the second partition member 412, as shown in FIGS. 12, 15, and 16. More specifically, the wall joint J3 included in the first partition member 411 is preferably formed on each rib L corresponding to the position of the wall joint J3 of the second partition member 412. In other words, the wall joint J3 included in the first partition member 411 and the second partition member 412 are formed in positions corresponding to each other up and down, preferably.

Therefore, if the first partition member 411 and the second partition member 412 are joined against each other, the wall joint J3 formed on each of the partition members are positioned to be consistent with each other in the vertical direction, and the first partition member 411 and the second partition member 412 are joined by a bolt or the like penetrating the wall joint J3 formed on each of the partition members. Here, a bolt penetrating each of the wall joints J3 may also penetrate the base plate 100 of the pack case 1000 to engage and secure the supplementary wall 400 and the base plate 100. Here, the bolts penetrate perpendicularly through the ribs L of the first partition member 411 to engage the supplementary wall 400.

The supplementary wall 400 included in the battery pack according to a third embodiment of the present invention is formed with holes on both sides. Specifically, it includes a first hole 411h penetrated to be in communication with a lower gas flow path 422 on one side and a second hole 412h penetrated to be in communication with an upper gas flow path 421 on the other side.

The first hole 411h is formed by penetrating a lower portion of the first partition member 411 to be in communication with the lower gas path 422, and the second hole 412h is formed by penetrating a lower portion of the second partition member 412 to be in communication with the upper gas path 421.

The supplementary wall 400 may also include a plurality of first holes 411h and second holes 412h on each side, as may the supplementary wall 400 included in the battery pack according to the second embodiment above.

FIG. 17 is a perspective view of a pack case 1000 included in a battery pack according to a third embodiment of the present invention.

Referring to FIG. 17, the first hole 411h and the second hole 412h are formed on both sides of the supplementary wall 400 to be in communication with respective containing spaces P. That is, any one containing space P may be formed by the main wall 200, the side wall 300, and the at least one supplementary wall 400.

The containing space P compartmented by the supplementary wall 400 on both sides may be in communication with both the first hole 411h of one supplementary wall 400 and the second hole 412h of the other supplementary wall 400, and the containing space P compartmented by the sidewall 300 on the other side of the supplementary wall 400 may be in communication with either the first hole 411h or the second hole 412h of the supplementary wall 400.

The present invention has been described in more detail above with reference to the drawings and embodiments. However, it is to be understood that the configurations shown in the drawings or embodiments described herein are only one example embodiment of the invention and do not represent all of the technical ideas of the invention, and that there may be various equivalents and modifications that may be substituted for them in the present application.

### DESCRIPTION OF REFERENCE NUMERALS

10: (Prior art) cell stack
1: (Prior art) battery cell
2: (Prior art) busbar frame
3: (Prior art) end plate
4: (Prior art) module frame
1000: pack case
100: base plate
200: main wall
300: side wall
310: front frame
320: rear frame
321: gas outlet
330: side frame
331: gas venting path
400: supplementary wall
411: first partition member
411h: first hole
412: second partition member
412h: second hole
420: gas flow path
421: upper gas flow path
422: lower gas flow path
430: opening
431: upper opening
432: lower opening
L: ribs
P: containing space
J1: main joint
J2: upper joint
J3: wall joint
Gp: gas

1. A battery pack accommodating a cell stack including one or more battery cells, the battery pack comprising:
a pack case having a space in which the cell stack is placed, the pack case comprising:
a base plate supporting a lower portion of the cell stack;
a main wall extending across the base plate and coupled to a center portion of the base plate;
a side wall having a hollow shape and including a gas venting path therein, and coupled along a periphery of an edge of the base plate; and
a plurality of supplementary walls, each of the plurality of supplementary walls having a front end coupled to the main wall, a rear end coupled to the side wall, a first partition member including a first pair of ribs extending in a longitudinal direction along a first side of the first partition member, and a second partition member coupled to the first partition member,
wherein at least one of the first partition member and the second partition member includes at least one first hole between the first pair of ribs.

2. The battery pack of claim 1, wherein each of the plurality of supplementary walls is arranged to be separately spaced along a longitudinal direction of the main wall.

3. The battery pack of claim 1, wherein the first pair of ribs are vertically spaced from each other by a predetermined distance.

4. The battery pack of claim 1, wherein the second partition member is coupled with the first partition member and faces the first pair of ribs of the first partition member.

5. The battery pack of claim 1, wherein the at least one first hole comprises a plurality of the first holes on one side of each of the plurality of supplementary walls.

6. The battery pack of claim 1, wherein a rear end of the first partition member has an opening in a space between the first pair of ribs.

7. The battery pack of claim 6, wherein each of the plurality of supplementary walls is inserted into the side wall to allow the opening to be in communication with the gas venting path.

8. The battery pack of claim 6, wherein each of the plurality of supplementary walls further comprises a gas flow path closed on an upper surface and a lower surface by the first pair of ribs, and closed on opposite sides by the first partition member and the second partition member, the gas flow path being open to the outside through the at least one first hole and the opening.

9. The battery pack of claim 1, wherein the second partition member comprises a second pair of ribs extending in a longitudinal direction along a first side of the second partition member, and
wherein each of the plurality of supplementary walls comprises a second hole between the second pair of ribs included on the second partition member on a side opposite the at least one first hole.

10. The battery pack of claim 9, wherein the second pair of ribs of the second partition member do not overlap the first pair of ribs formed on the first partition member.

11. The battery pack of claim 9, wherein the second pair of ribs of the second partition member is located on top of the first pair of ribs formed on the first partition member, and
wherein the at least one first hole and the second hole are formed on opposite sides of the supplementary wall at a lower and upper portion, respectively.

12. The battery pack of claim 9, wherein a rear end of each of the first partition member and the second partition member have an opening between the second pair of ribs on the second partition member to form an upper opening.

13. The battery pack of claim 12, wherein a rear end of each of the first partition member and the second partition member have an opening between the first pair of ribs on the first partition member to form a lower opening, and
wherein each of the plurality of supplementary walls is inserted into the side wall to allow the upper opening and the lower opening to be in communication with the gas venting path.

14. The battery pack of claim 9, wherein each of the plurality of supplementary walls comprises the at least one first hole and the second hole on each side.

15. The battery pack of claim 9, wherein the supplementary wall comprises:
an upper gas flow path, closed on an upper surface and a lower surface by the second pair of ribs formed in the second partition member, and closed on opposite sides by the first partition member and the second partition member; and
a lower gas flow path located below the upper gas flow path, closed on an upper surface and a lower surface by the first pair of ribs formed in the first partition member and closed on opposite sides by the first partition member and the second partition member, and
wherein the upper gas flow path and the lower gas flow path are not in communication with each other within the supplementary wall.
